(19) United States
(12) Patent Application Publication
(10) Pub. No.: US 2014/0184781 A1
(43) Pub. Date: Jul. 3, 2014

(54) FURNACE TUBE INSPECTION

(71) Applicant: HONEYWELL INTERNATIONAL INC., Morristown, NJ (US)

(72) Inventors: Kwong Wing Au, Bloomington, MN (US); Sharath Venkatesha, Golden Valley, MN (US)

(73) Assignee: HONEYWELL INTERNATIONAL INC., Morristown, NJ (US)

(21) Appl. No.: 13/730,907

(22) Filed: Dec. 29, 2012

(51) Int. Cl. H04N 7/18

(52) U.S. Cl. CPC H04N 7/18
USPC 348/83

(57) ABSTRACT

Devices, methods, and systems for determining a layout for a heating, ventilation, and air conditioning (HVAC) system of a building are described herein. One method includes receiving information from a building information model associated with a building, receiving information from a pre-engineering tool associated with the building, and determining a layout for an HVAC system of the building based, at least in part, on the information form the building information model and the information from the pre-engineering tool.

### TECHNICAL FIELD

The present disclosure relates to devices, methods, and systems for furnace tube inspection.

### BACKGROUND

Regular on-stream inspection of furnace tubes is important to furnace safety and its maintenance. These inspections identify the early signs of leaks and/or rupture of tubes, thus preventing potential damage and/or maintaining reliability.

One on-stream inspection method is visual based inspection. Another method is based on thermal scanning of the furnace tubes using a portable thermal camera. Both require manual operation by a trained operator. Many procedural missteps and/or variations can cause inaccurate or even erroneous analyses.

Additionally, acquiring good quality thermal images using an expensive portable camera during an inspection has many unmet challenges. For example, one challenge is the correct registration of the acquired image with the particular view port of the furnace at which the image was taken.

Further, the number of images taken per view port and the order of inspecting the view ports could be different for each operator and/or from day to day thereby resulting in irregularities. Additionally, a thermal camera has many settings that enable the captures of good images under diverse operating conditions. However, incorrect or inconsistent settings can cause poor or different image captures.

One such setting is the temperature range. Furnaces can operate at different temperatures as required by various processes. Achieving optimal temperature resolution in an image, thus, requires correctly setting the temperature range of the camera, which could be different for each view port and could be different at each inspection time.

The distance from the view port to a furnace surface (e.g. opposite wall of the furnace) depends on the camera view angle and can also differ based on the location of a view port. In such applications, obtaining a sharp image can require adjusting the focus of the camera. A sharp image also can require steadily holding the camera avoiding any motion blur.

Viewing aspect can also be important in some applications. For example, a view port can be bigger than lens of the camera. Thus, the field of regard of a view port is bigger than the field of view of the camera. Depending on the aspect angle of the camera (due to holding the camera at various tilt, yaw, and pitch angles), an operator may take an image covering only part of the field of regard. Capturing images that cover the entire field of regard can be important to identify all potential issues with the furnace.

### BRIEF DESCRIPTION OF THE DRAWINGS

FIG. 1 illustrates a furnace having a number of view ports for use with one or more embodiments of the present disclosure.

FIG. 2 illustrates several images showing different parts of the furnace that may be captured when viewing through the view ports of the furnace in accordance with one or more embodiments of the present disclosure.

FIG. 3 illustrates a system for taking images through the view ports of a furnace in accordance with one or more embodiments of the present disclosure.

FIG. 4 illustrates several different thermal images at different temperature ranges that may be seen when viewing the furnace through the view ports of a furnace in accordance with one or more embodiments of the present disclosure.

FIG. 5 illustrates a furnace having a number of view ports which provide internal views of the furnace at different depths, for use with one or more embodiments of the present disclosure.

FIG. 6 illustrates an embodiment where a number of view ports have different fields of view than their field of reference.

FIG. 7 illustrates a system having a number of alignment keys at a view port and illustrates a stitching capability in accordance with one or more embodiments of the present disclosure.

### DETAILED DESCRIPTION

Devices, methods, and systems for furnace tube inspection are described herein. Embodiments of the present disclosure for example, can provide furnace tube diagnosis using a portable thermal camera and, in some embodiments, can perform potential problem detection and/or furnace tube health monitoring and/or reliability maintenance monitoring.

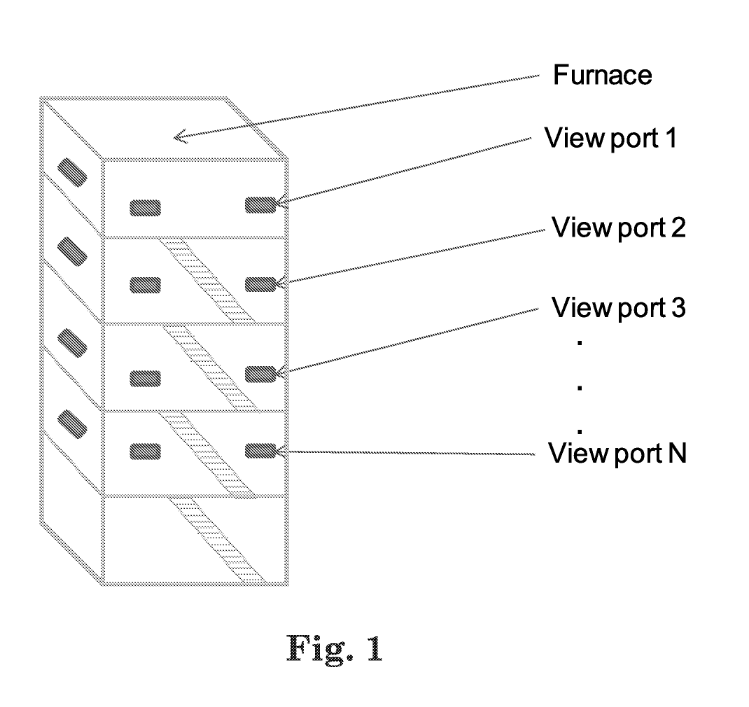

FIG. 1 illustrates a furnace having a number of view ports for use with one or more embodiments of the present disclosure. As discussed above, the furnace can have a variety of different characteristics that may change the way that the images should be taken to provide a number of images of adequate quality for analysis of furnace condition. For example, some characteristics include, the viewable area (i.e., field of regard) that can be seen from the view port, the depth of furnace surface to be viewed in focus within the view port (i.e. depends on the camera focal length and depth of focus), and/or the temperature of the furnace at the time the image is taken.

In the furnace illustrated in FIG. 1, the furnace has several view ports (e.g., view ports 1, 2, 3, . . . N) that are accessible for viewing the interior of the furnace. As can be seen from the positioning of the view ports on the furnace, the view ports can be positioned in any suitable location and can provide a variety of images of the interior of the furnace.

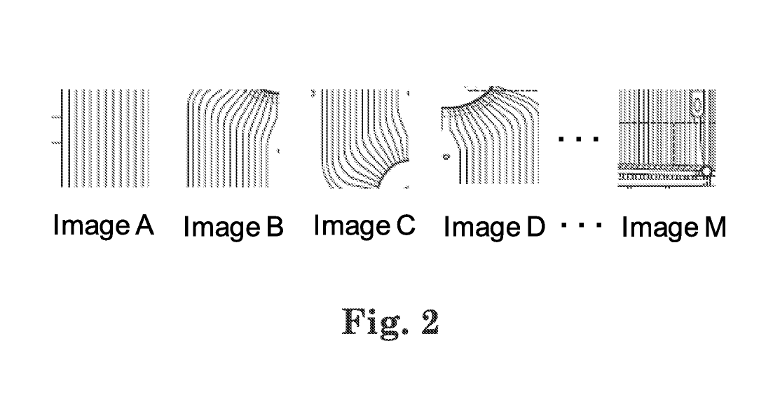

FIG. 2 illustrates several images showing different parts of a furnace that may be captured when viewing through the view ports of the furnace in accordance with one or more embodiments of the present disclosure. FIG. 2 provides several different viewing examples, (e.g., images A, B, C, D, . . . M) may be capable of image capture from view ports 1, 2, 3, . . . N.

In some embodiments, multiple images can be taken through the same view port. For example, images A and B, of those shown in FIG. 2 could both have been taken through view port 1 of FIG. 1. For instance image A may have been taken with the camera oriented in a first position wherein the field of view is different that the orientation in which image B was taken wherein the camera was in a second position. Accordingly, where the field of reference at a view port is larger than can be captured by the field of view of the camera, in some embodiments, the camera can be placed in multiple positions to capture more than one portion of the field of reference.

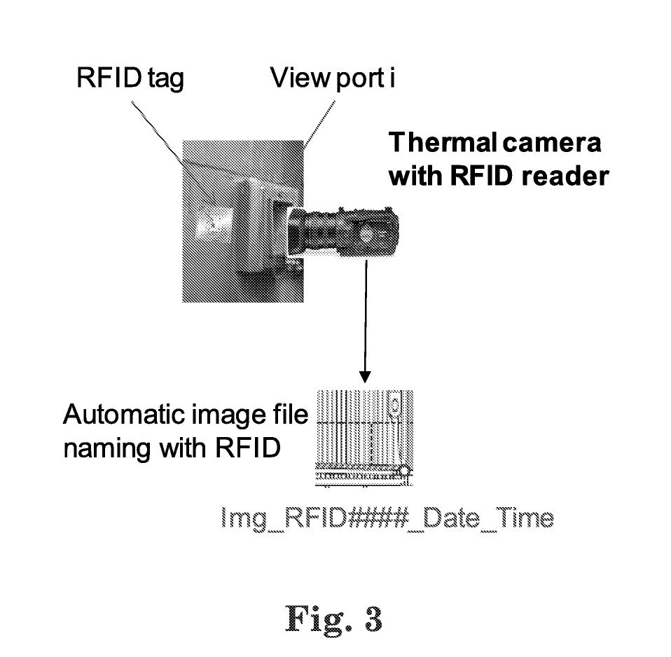

FIG. 3 illustrates a system for taking images through the view ports of a furnace in accordance with one or more embodiments of the present disclosure. In the embodiment of FIG. 3, a view port is marked with a machine readable identification tag (e.g., a radio frequency identification (RFID) tag) that provides identity information of the view port. Based on this identity, relevant information, such as location, temperature, focus, and/or other information that may be helpful in capturing one or more images of the desired quality from the viewport can be retrieved remotely from a server or locally from the thermal camera.

In various embodiments of the present disclosure, the reading component receives one or more of the informational items and uses the items to set the imaging device to one or more of a specific zoom, specific focus, and specific temperature settings for image capture.

The readable identification tag includes a machine readable identifier that allows the location of the view port to be provided to a radio frequency identification reader device. This device can store the identification in memory either on the device or stored in another memory location (e.g., transmitted via a network to another device for storage of the information).

In some embodiments, the machine readable tag is a passive identifier tag that is energized when within a threshold proximity to the reading component (wherein the threshold is close enough to energize the tag).

In such embodiments, the reader provides the power needed to energize the tag. For example, the machine readable tag can be an active identifier tag that provides to the reading component one or more of the following items: the identity information, the temperature range of the furnace pipes which can be viewed through the view port, the depth of the pipes from the view port, and the distance of the pipes from the viewport.

The readable identifier can be associated with the images taken at the view port that the identifier represents. For example, the image file and the identifier can be separate files and associated by the a common file name or portion of a file name (e.g. port 1.dat and port 1.img) or the identifier can be added to the image file, for example, to the file name or to the header information of the image file.

For example, one association type is the embedding of the identity and other information, such as date and time, in the image file name or metadata associated with the file. This identity of the viewport can be used in many other instances, for example, such as those described below.

One suitable example of an association of the identifier with the image is a name of the image file such as: 1 mg_RFID###_Date_Time. However, any suitable arrangement for associating the image file and the identifier information can be utilized in the embodiments of the present disclosure. Such an association can be utilized, for example, to register the file and identifier information in a database or other data resource, characterize the image, fusing the image and identifier information to allow for the information to be moved together, and organizing the information, among other benefits.

In some embodiments, the machine readable identification tag can use different technology or work in a different frequency band. These include ultrasonic sensors, near field communication (NFC), etc. In other embodiments, the identification tags can be camera/imager readable such as bar codes or similar types in visible or non-visible spectral range, which are placed dose to the viewport.

In some embodiments, the identifier can be read by the reader before any images are taken at the location. In some such embodiments, the identifier can then be associated with each new image taken.

This can be accomplished at the time the images are taken or subsequently, for example, based on a recorded time that the identifier was read and the times that the images were taken (e.g., images with times subsequent to the reading of a first identifier, but before a reading of a second identifier, can be associated with the first identifier). This type of association of the images and the identifier can be accomplished manually, by a user selecting one or more images to associate with an identifier or automatically, via computing device executable instructions that can select the identifier and images to associate based upon one or more sets of rules, such as those discussed above.

One example embodiment of a furnace inspection imaging device includes an imaging component (e.g., an imaging sensor or mechanical camera components) for capturing images of a portion of a furnace, a reading component for reading a machine readable tag placed at a specific view port of a furnace, wherein the reading component reads the tag to obtain unique identity information indicating its physical location at the furnace, and a processor and computing device executable instructions executable by the processor for associating images taken by an imaging device at the specific view port with the identity information. As discussed herein, the device can adjust the imaging component to operate, at specific temperatures, in multiple specific temperature ranges, and with specific focus settings, wherein the selection of at least one of the specific temperature or temperature range and focus setting is based on the position information read by the reading component.

The imaging component utilized to capture the images can be any suitable image sensor or camera device. In some embodiments, the imaging component can be a video camera and the device can execute instructions to perform video analytics on the captured images.

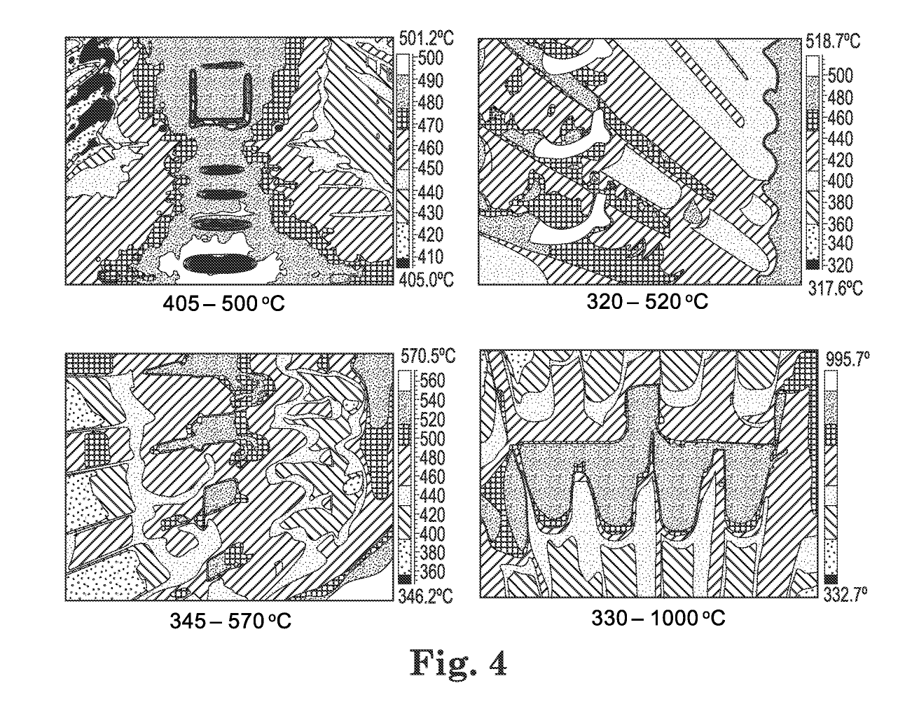

FIG. 4 illustrates several different thermal images at different temperature ranges that may be seen when viewing the furnace through the view ports of a furnace in accordance with one or more embodiments of the present disclosure. As discussed above, the furnace can have areas that have different temperatures and when viewed through the different view ports, the same settings on a thermal camera would be inadequate for taking images of the different areas.

Additionally, different furnaces can have different operating temperatures (overall or at different locations therein) and as such, a user traveling from one furnace to another may have difficulty knowing the correct camera settings for taking images at the various view port locations. Further, in some embodiments, the furnace may have several different operational states and the temperatures may be different during these different states of operation.

In such embodiments, the identifier information can include temperature information for the view port at which the identifier is located or general temperature information for the furnace. Once the identifier has been read by the reader, this temperature information can be presented to the user (e.g., on a display on the camera) or can be read by computing device executable instructions and the camera can be automatically adjusted in preparation for taking images from the view port. In some embodiments, this temperature information can be stored in memory (e.g., on the camera or in memory accessible by the camera) as data that is associated with the identifier and when the identifier is read by the reader, computing device executable instructions can associate the data stored in memory with the identifier and provide that information to a processor within the camera to automatically adjust the camera's image taking settings or to present the information on a display to allow a user to make the adjustments.

The information provided can be any information suitable for improving the quality of the images to be taken. Examples of suitable information include, but are not limited to, specific temperature, temperature ranges, specific camera settings, timing information for different furnace states, and/or furnace model and/or type information.

In some embodiments, the camera automatically adjusts the temperature setting to acquire a set of images at a particular temperature range. This can be accomplished, for example, by, before the inspection process begins, the furnace operating conditions and other furnace information, if needed, are downloaded to the memory of the thermal camera. This information can be downloaded from one or more computing devices that are connected wired or wirelessly and/or directly or via a network.

In some such embodiments, the expected temperature range of the furnace viewed at the identified view port (using the identifier tag identification process) can be retrieved from memory (e.g., a lookup table) based on the furnace operating conditions. To further ensure the proper temperature range is selected, the acquired image can be analyzed to make sure that its histogram has a fairly uniform distribution (within a threshold amount of deviation) across the dynamic range of the possible values. If the distribution is distorted, the temperature range of the camera can be adjusted and the images are re-acquired.

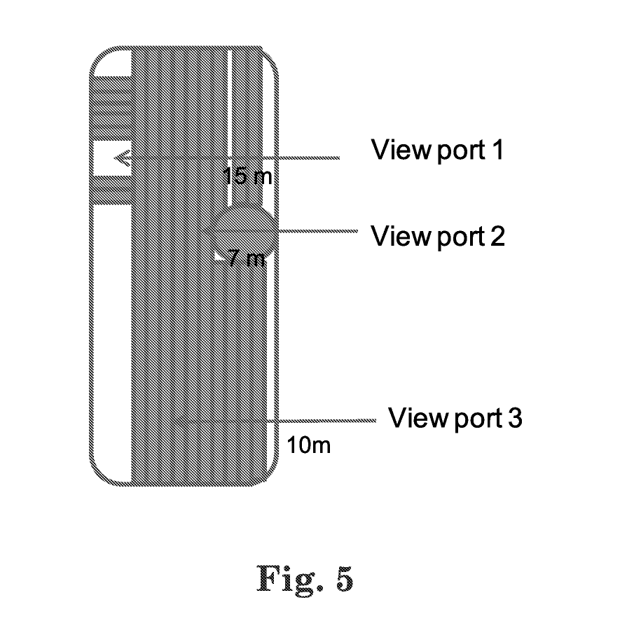

FIG. 5 illustrates a furnace having a number of view ports which provide internal views of the furnace at different depths, for use with one or more embodiments of the present disclosure. In some embodiments, the camera focus may need to be adjusted for changes in furnace depth based on the view port and the view angle in which the images are to be taken. For instance, as illustrated in FIG. 5, at view port 1 the furnace depth is 10 m, at view port 2 the furnace depth is 20 m, and at view port 3 it is 7 m.

In such embodiments, the identifier information can include the furnace depth information for the view port at which the identifier is located or general depth of field information for the furnace. As with the thermal information discussed above, once the identifier has been read by the reader, this depth information can be presented to the user (e.g., on a display on the camera) or can be read by computing device executable instructions and the camera focus settings can be automatically adjusted in preparation for taking images from the view port. In some embodiments, this information can be stored in memory (e.g., on the camera or in memory accessible by the camera) as data that is associated with the identifier and when the identifier is read by the reader, computing device executable instructions can associate the data stored in memory with the identifier and provide that information to a processor within the camera to automatically adjust the camera's image taking settings or to present the information on a display to allow a user to make the adjustments.

The information provided can be any information suitable for improving the quality of the images to be taken. Examples of suitable information include, but are not limited to, furnace depth for the view port, furnace depths of multiple locations within the view port based on the camera yaw, pitch and tilt angles (i.e., if multiple images are to be taken from the view port of different fields of view), furnace depth ranges, best camera focus settings required for the furnace depth based on the camera type, and/or furnace model and/or type information.

Through such embodiments, the device can have the capability to capture images which are in focus. As discussed above, the distance, for example, from the view port to the furnace tubes within the furnace can differ at each view port and sometimes at different fields of view within a field of reference at a view port.

Manual focus adjustment can be difficult as the operator often wears protection gear when capturing images at the view port location. The protection gear often includes use of gloves etc., which make it hard for the operator to push buttons on the camera to change the camera settings. With help of the view port identifier, the focus setting information can be obtained from the identifier information or from memory (e.g., a look up table) and the operator presets the camera with the desired focus setting.

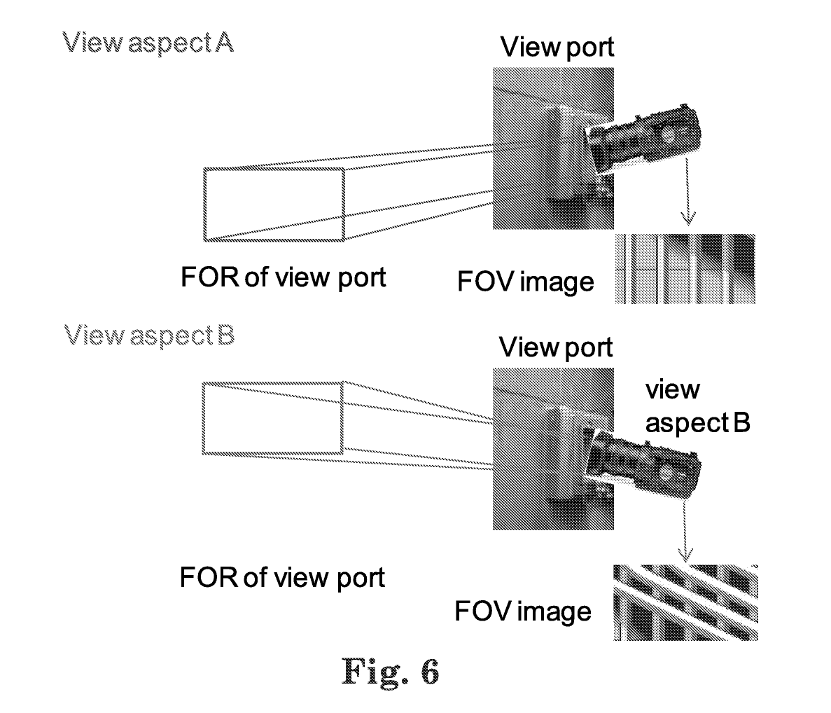

FIG. 6 illustrates an embodiment where a viewport has a field of regard and the camera can be positioned to get different fields of view. In some embodiments, the view port may have a large field of regard (e.g., the field of regard of a viewport is larger than the field of view of the camera and therefore the user cannot capture everything viewable from the view port with one image) and as such, it may be useful to take more than one image from the view port in order to capture images of multiple items that cannot be captured in one image based on the limited field of view of the camera. In such instances, the position of the camera may need to be adjusted in order to capture the desired images based on the view port in which the images are to be taken.

For instance, as illustrated in FIG. 6, at a particular view port it is desirable to take an image from view aspect A which requires a first camera position and to take an image from view aspect B which requires a second camera position. As is illustrated in FIG. 6, the resulting field of view images (FOV Image) do not show the same features because they are capturing different portions of the field of regard of the view port (FOR of view port).

In such embodiments, the identifier information can include field of view, field of regard, and/or camera positioning information for the view port at which the identifier is located. As with the furnace depth information discussed above, once the identifier has been read by the reader, this field of view, field of regard, and/or camera positioning information can be presented to the user (e.g., on a display on the camera or via voice output) or can be read by computing device executable instructions and the camera can be automatically adjusted in preparation for taking images from the view port. In some embodiments, this field of view, field of regard, and/or camera positioning information can be stored in memory (e.g., on the camera or in memory accessible by the camera) as data that is associated with the identifier and when the identifier is read by the reader, computing device executable instructions can associate the data stored in memory with the identifier and provide that information to a processor within the camera to automatically adjust the camera's image taking settings or to present the information on a display to allow a user to make the adjustments.

The information provided can be any information suitable for improving the quality of the images to be taken. Examples of suitable information include, but are not limited to, field of regard at a particular view port, one or more fields of view within a field of regard and/or at a particular view port, camera positioning for each of the one or more fields of view, and/or furnace model and/or type information.

Embodiments of the present disclosure, such as those described with respect to the example in FIG. 6 may be beneficial in many instances. In one such example, many infrared (IR) cameras have a maximum achievable field of view (FOV) of 24 degrees, whereas the field of regard (FOR) of a viewport can be well above 120 degrees. The FOV can be greatly reduced if a lens of a higher focal length is used in order to capture an image at a farther distance.

Such usage restricts the amount of information captured from a single image at any given view port, and multiple images may be needed to capture the overall information. An image mosaic constructed from multiple images from a view port can, in some instances, provide a composite image of the full field of regard.

One potential problem with capturing multiple images is that the images should be associated with each other (i.e. possible to be registered) and should have minimal motion blur. The process can be difficult if an operator freely moves the camera and points it at random angles to capture images in the viewport.

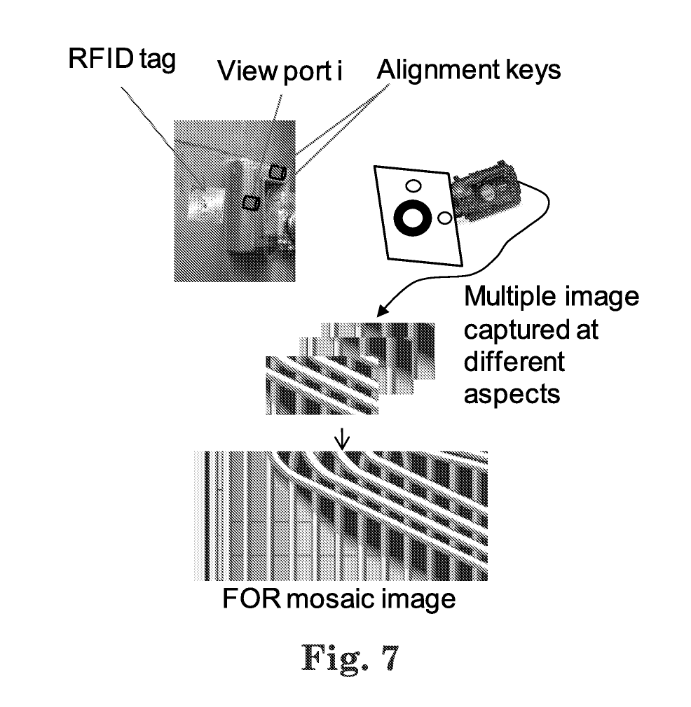

Accordingly, embodiments of the present disclosure utilize one or more alignment key parts that can be fixed at preset positions (which correspond to different camera FOVs) at a view port and the camera can have corresponding key parts which will mate with the alignment key parts at the view port. FIG. 7 shows a camera in an arrangement such that it captures images corresponding to different camera FOVs from position A and position B. The camera will be able to tag the images with the specific position and sequence information which will be used later for registering image pairs. Such embodiments can ensure the order of capture of multiple images and/or avoid motion blur.

In some embodiments, the device is a portable IR camera with a built-in identifier reader. In various embodiments, the reader and the camera are separate devices that communicate with each other. In some embodiments, the device includes hardware (e.g., a processor and memory) and computing device executable instructions to analyze the images, adjust the camera's settings, and/or transfer the data or other information to and/or from the device to a computing device.

In various embodiments, a system includes a camera with one or more alignment key parts thereon, an identifier tag and one or more alignment key parts at the view port, and/or a computing device which has hardware (e.g., a processor and memory) and computing device executable instructions to transfer information to and/or from the camera and/or analyze the images. In such embodiments, the computing device can have or be in communication (wired or wirelessly) with memory that can store furnace information and/or data as discussed above.

As used herein, a camera or computing device can include a memory and a processor coupled to the memory. The memory can be any type of storage medium that can be accessed by the processor to perform various examples of the present disclosure. For example, the memory can be a non-transitory computer readable medium having computer readable instructions (e.g., computer program instructions) stored thereon that are executable by the processor to store the image data or files in accordance with one or more embodiments of the present disclosure.

The memory can be volatile or nonvolatile memory. The memory can also be removable (e.g., portable) memory, or non-removable (e.g., internal) memory. For example, the memory can be random access memory (RAM) (e.g., dynamic random access memory (DRAM) and/or phase change random access memory (PCRAM)), read-only memory (ROM) (e.g., electrically erasable programmable read-only memory (EEPROM) and/or compact-disc read-only memory (CD-ROM)), flash memory, a laser disc, a digital versatile disc (DVD) or other optical disk storage, and/or a magnetic medium such as magnetic cassettes, tapes, or disks, among other types of memory.

Further, the memory can be located in the camera or can be located internal to or connected to a computing device resource (e.g., enabling computer readable instructions to be downloaded over the Internet or another wired or wireless connection). Accordingly, in some embodiments, the device or system can include a communication component wherein furnace operating condition data or other data (e.g., captured images and associated information) can be communicated to or received from another device.

In various embodiments, the identifier tag at a view port can store the location ID, the temperature range of the furnace generally and/or pipes which can be viewed through the view port, and/or the depth (e.g., distance) of the items to be imaged (e.g., pipes) from the view port. This information can, for example, be read by the identifier tag reader on the camera and can be used to set the camera to the required zoom, focus, and/or temperature settings for desired image capture.

Memory can be utilized for storage of a variety of information including image data of the captured images, identity information data, and/or executable instructions for associating the identity information with one or more images, processing the image data, and/or analyzing the data. In some such embodiments, expected temperature range data of the furnace viewed at the specific view port can be selected from a lookup table stored in memory within the imaging device or from another device via the communication component, wherein the expected temperature data is selected based on the furnace operating conditions and the identity information.

In various embodiments, the imaging device with memory and processor can include executable instructions to automatically adjust a temperature setting used for acquiring an image at a specific view port at a specific temperature range based upon the received furnace operating condition data. In some embodiments, the imaging device can include executable instructions to automatically adjust a temperature setting used for acquiring an image at a specific view port at a specific temperature range based upon one or more image characteristics received from the other device. Embodiments can also include executable instructions to automatically adjust a focus setting used to acquire an image at a specific view port based upon the view port location and camera position setting information obtained from the reading component.

In various embodiments, the processor can execute instructions to provide multiple functionalities, including to associate new images with metadata including at least one of position, temperature, and sequence information with other images, to perform video analytics, and to monitor the health of the furnace by modeling the operating scenarios via recorded data over time.

Any of the above information can be saved along with the captured image as metadata or in the form of a data file which can be available later for image processing or to aid in future image capture.

FIG. 7 illustrates a system having a number of alignment keys at a view port and illustrates a stitching capability in accordance with one or more embodiments of the present disclosure. As discussed above, in some embodiments, the view port may have a large field of reference and as such, it may be useful to take more than one image from the view port in order to capture images of multiple items that cannot be captured in one image based on the limited field of view of the camera.

In some such instances, it may be desired to take images in a particular sequence such that the position of the camera may need to be adjusted in order to capture the desired images based on the view port in which the images are to be taken and based upon the order in which the images are to be captured.

For instance, it may be useful to compare images from previous visits by the user to determine changes from one visit to the next. If the pictures are in the same sequence, it can make it easy to compare from one visit to the next and may make it easy to determine that the images or from the same location and the same view.

Having the images in a sequential order may also be helpful if the images are to be stitched together. Stitching allows multiple images to be combined together to create a larger composite of the images.

If the images are taken in a particular sequence and the user or the computing device doing the stitching operation knows the sequence, then the stitching operation can be done more efficiently. Whether in order or not, the location information discussed above can provide helpful information to put the images in the correct order for stitching.

Additionally, when the camera is held by the user, the position of the camera may be slightly different from one visit to the next, so it may be difficult to compare the two images accurately in some situations. Accordingly, in some embodiments, one or more keys may be used to secure the camera in position so that an image can be taken at a particular position and orientation repeatedly (e.g., each time the user makes a visit to the furnace).

The one or more keys can be any mechanism that can fix a camera temporarily in a position. In various embodiments, the alignment component includes a motor or hand operated position and/or angle controller mechanism wherein the hand operated mechanism utilizes alignment key-slot pairs. For example, the key can be a hole located on a plate proximate to the view port with a corresponding pin (that fits in the hole) to maintain the camera in the proper position and orientation while the image is being taken.

In some embodiments, the key may be multiple holes and multiple pins wherein each pin goes in one of the holes such that camera is stabilized from more than one point. In some such embodiments, the holes and pins may be arranged so that the camera can only be mounted in the holes in one position and therefore, an operator cannot mistakenly mount the camera in the wrong orientation and take incorrect images.

In some embodiments, multiple holes can be provided and one or more pins on the camera can be moved from a first set of holes (one or more) to a subsequent set (e.g., a set of holes including at least one other hole) in order to take multiple images through a view port. In some such embodiments, the sets of holes can be ordered, so the camera can be moved from one set to another set in a sequence.

As discussed above, any suitable mechanism for aligning the camera can be utilized and the above concepts (e.g., providing multiple positions, providing the positions in sequence) can also be utilized with such mechanisms.

One example furnace inspection system embodiment having such features includes an imaging device having: an imaging component for capturing images of a portion of a furnace, a reading component for reading a machine readable tag placed at a specific view port of a furnace, wherein reading component reads the tag to obtain unique identity information indicating its physical location at the specific view port, and a processor for associating images captured by the imaging component at the specific view port with the identity information; and an alignment component that engages with the imaging device for positioning the imaging device at one or more of a particular angle or distance with respect to the view port.

In some embodiments, the alignment component can be designed for the imaging device to be positioned at multiple predefined positions to capture images of different portions of the furnace in a predefined sequence as the imaging device is looking through the viewport and the processor executes instructions to create an image mosaic by stitching the captured images of the different portions of the furnace using predefined position and image sequence information.

As discussed above, embodiments of the present disclosure can automate the registration of the view port identity and the captured images, thus ensuring all images are correctly registered and avoiding human error in recording and analyzing the images.

In the following detailed description, reference is made to the accompanying drawings that form a part hereof. The drawings show by way of illustration how one or more embodiments of the disclosure may be practiced.

These embodiments are described in sufficient detail to enable those of ordinary skill in the art to practice one or more embodiments of this disclosure. It is to be understood that other embodiments may be utilized and that process changes may be made without departing from the scope of the present disclosure.

As will be appreciated, elements shown in the various embodiments herein can be added, exchanged, combined, and/or eliminated so as to provide a number of additional embodiments of the present disclosure. The proportion and the relative scale of the elements provided in the figures are intended to illustrate the embodiments of the present disclosure, and should not be taken in a limiting sense.

The figures herein follow a numbering convention in which the first digit or digits correspond to the drawing figure number and the remaining digits identify an element or component in the drawing. Similar elements or components between different figures may be identified by the use of similar digits.

As used herein, “a” or “a number of” something can refer to one or more such things. For example, “a number of components”can refer to one or more components.

Although specific embodiments have been illustrated and described herein, those of ordinary skill in the art will appreciate that any arrangement calculated to achieve the same techniques can be substituted for the specific embodiments shown. This disclosure is intended to cover any and all adaptations or variations of various embodiments of the disclosure.

It is to be understood that the above description has been made in an illustrative fashion, and not a restrictive one. Combination of the above embodiments, and other embodiments not specifically described herein will be apparent to those of skill in the art upon reviewing the above description.

The scope of the various embodiments of the disclosure includes any other applications in which the above structures and methods are used. Therefore, the scope of various embodiments of the disclosure should be determined with reference to the appended claims, along with the full range of equivalents to which such claims are entitled.

In the foregoing Detailed Description, various features are grouped together in example embodiments illustrated in the figures for the purpose of streamlining the disclosure. This method of disclosure is not to be interpreted as reflecting an intention that the embodiments of the disclosure require more features than are expressly recited in each claim.

Rather, as the following claims reflect, inventive subject matter lies in less than all features of a single disclosed embodiment. Thus, the following claims are hereby incorporated into the Detailed Description, with each claim standing on its own as a separate embodiment.

What is claimed:

1. A furnace inspection imaging system, comprising:
an imaging component for capturing images of a portion of a furnace;
a reading component for reading a machine readable tag placed at a specific view port of a furnace, wherein the reading component reads the tag to obtain unique identity information indicating its physical location at the furnace; and
a processor and computing device executable instructions executable by the processor for associating images taken by an imaging device at the specific view port with the identity information;
a memory component for storage of one or more of image data of the captured images, view port, and furnace characteristics and identity information data; and
a user interface component for display and interactive communication to and from the user.

2. The system of claim 1, wherein the imaging component is a thermal camera.

3. The system of claim 2, wherein the system is adjustable to operate in multiple camera settings including at least one of specific temperature ranges, aperture, shutter speed, and focus and wherein the selection of at least one of the camera settings is based on information derived from the view port identity read by the reading component.

4. The system of claim 3, wherein the system includes at least one of a wired and wireless communication component wherein
furnace operating condition data that is received from a device connected to the communication component is updated in the memory component; and
the captured images and associated information are sent to the same or another connected device.

5. The system of claim 3, wherein the machine readable tag is a passive identifier tag that is energized when within a threshold proximity to the reading component.

6. The system of claim 5, wherein the processor identifies in the memory component one or more characteristics of the view port of interest, including at least one of the identity information, the temperature range of the furnace pipes which can be viewed through the view port, the depth of the pipes from the view port, and the distance of the pipes from the viewport based on the view port identify from reading the identifier tag.

7. The system of claim 3, wherein the machine readable tag is an active identifier tag that provides to the reading component one or more of the following items: the identity information, the temperature range of the furnace pipes which can be viewed through the view port, the depth of the pipes from the view port, and the distance of the pipes from the viewport.

8. The system of claim 3, wherein the system automatically adjusts a temperature setting used for acquiring an image at a specific view port at a specific temperature range based upon the received furnace operating condition data.

9. The system of claim 3, wherein the system automatically adjusts a temperature setting used for acquiring an image at a specific view port at a specific temperature range based upon one or more image characteristics computed from the processor.

10. A furnace inspection imaging device, comprising:
an imaging component for capturing images of a portion of a furnace;
a reading component for reading a machine readable tag placed at a specific view port of a furnace, wherein reading component reads the tag to obtain unique identity information indicating its physical location at the furnace;
a processor and computing device executable instructions executable by the processor for associating images taken by an imaging device at the specific view port with the identity information; and wherein expected temperature range data of the furnace viewed at the specific view port is selected from memory within the imaging device or from another device via the communication component, wherein the expected temperature data is selected based on the furnace operating conditions and the identity information.

11. The imaging device of claim 10, wherein the imaging device automatically adjusts at least one of the camera settings including a focus setting used to acquire an image at a specific view port based upon the location of viewport of interest and the corresponding camera position setting information obtained from the memory component.

12. The imaging device of claim 10, wherein the imaging device automatically adjusts at least one of the camera settings including a focus setting used to acquire an image at a specific view port based upon the image characteristics computed from the processor.

13. The system of claim 10, wherein an alignment component is provided that allows the imaging device to be positioned at multiple predefined positions to capture images of different portions of the furnace in a predefined sequence as the imaging device is looking through the viewport;

14. The system of claim 13 wherein the processor executes instructions to create an image mosaic by stitching the captured images of the different portions of the furnace at the view port of interest using predefined position and image sequence information.

15. The system of claim 13, wherein the alignment component includes a motor or hand operated position controller mechanism wherein the hand operated mechanism utilizes alignment key-slot pairs.

16. The system of claim 13, wherein the processor acquires directly from the identifier tag or indirectly through lookup from the viewport identity one or more of the following items: the identity information, the temperature range of the furnace pipes which can be viewed through the view port, the depth of the pipes from the view port, and the distance of the pipes from the viewport.

17. The imaging device of claim 13, wherein the imaging device automatically adjusts a temperature setting used for acquiring an image at a specific view port at a specific temperature range based upon the received furnace operating condition data.

18. The imaging device of claim 13, wherein the imaging device automatically adjusts a temperature setting used for acquiring an image at a specific view port at a specific temperature range based upon one or more image characteristics computed from the processor.

19. A furnace inspection imaging device, comprising:
an imaging component for capturing images of a portion of a furnace;
a reading component for reading a machine readable tag placed at a specific view port of a furnace, wherein reading component reads the tag to obtain unique identity information indicating its physical location at the furnace; and
a processor and computing device executable instructions executable by the processor for associating images taken by an imaging device at the specific view port with the identity information.

20. The device of claim 19, wherein the processor executes instructions to provide multiple functionalities, including to:
associate new images with metadata including position, temperature, and sequence information with other images to perform video analytics; and
monitor the health of the furnace by modeling the operating scenarios via recorded data over time.
